(19) United States
(12) Patent Application Publication
(10) Pub. No.: US 2013/0125590 A1
(43) Pub. Date: May 23, 2013

(54) RECONDITIONING GLASS-FORMING MOLDS

(71) Applicants: Jiangwei Feng, Painted Post, NY (US); Janet Mitchell, Elmira, NY (US); Ljerka Ukrainczyk, Painted Post, NY (US)

(72) Inventors: Jiangwei Feng, Painted Post, NY (US); Janet Mitchell, Elmira, NY (US); Ljerka Ukrainczyk, Painted Post, NY (US)

(21) Appl. No.: 13/666,321

(22) Filed: Nov. 1, 2012

Related U.S. Application Data
(60) Provisional application No. 61/563,192, filed on Nov. 23, 2011.

(51) Int. Cl. C03B 9/48; C03B 7/14; B28B 7/38

(52) U.S. Cl. 65/122; 427/133; 65/374.12

(57) ABSTRACT

Glass-forming molds comprising titanium aluminum nitride glass release coatings are reconditioned with aqueous mineral acid solutions comprising fluoride and phosphate ions to provide molds with restored glass release characteristics without recoating, permitting the molding of glass articles from aggressive ion-exchange-strengthenable high-alkali aluminosilicate glasses at high temperatures over extended mold service intervals.

This application claims the benefit of priority under 35 U.S.C. §119 of U.S. Provisional Application Ser. No. 61/563,192 filed on November 23, 2011 the content of which is relied upon and incorporated herein by reference in its entirety.

### BACKGROUND

The precision molding of complex glass shapes from high-softening-point alkali-metal-containing silicate glasses is complicated by the refractory nature and chemically aggressive character of such glasses. The high softening points of alkali aluminosilicate glasses (often above 800° C.) make molding difficult because of the higher working temperatures required to reach the visco-elasticities needed for accurate forming Further, the alkali metal constituents of such glasses are highly mobile and reactive with mold surfaces at high working temperatures, rapidly leading to mold surface degradation and resulting damage to the cosmetic quality of molded glass surfaces. The extreme thermal and mechanical cycling to which such molds are subjected also limits the range of mold and mold coating materials that can be selected for such molding applications.

Metals such as cast iron, stainless steel, copper alloys and nickel super alloys are frequently used to fabricate glass-forming molds, but most are subject to surface oxidation at temperatures above 600° C. in air. In addition, such metals can react with alkali ions present in molten glass at typical glass-forming temperatures, producing alkali-modified mold surfaces that are increasingly glass-adherent. The resulting sticking between the glass and mold surfaces eventually degrades the surface qualities of both the molds and the glass articles being formed. Alternative mold fabrication materials such as SiC, SiN, and Sialon (SI—Al—O—N) ceramics have been tried to address some of these problems, but ceramic mold materials are expensive and difficult to machine, and do not totally eliminate the sticking problems encountered during the forming of high-softening-point alkali-containing glasses.

One established approach for facilitating the forming of refractory alkali aluminosilicate glass articles with defect-free molded surfaces is the use of titanium-nitride-based (TiN) release coatings, i.e., mold surface coatings consisting predominantly of refractory coating materials such as titanium aluminum nitride (Ti—Al—N). In general, the extended glass release properties and reduced interfacial reactivities of such coatings against molten alkali aluminosilicate glasses have been found to preserve molded glass surface quality and provide closer control of dimensional tolerances for molded glass articles over somewhat longer service periods due to the higher chemical stability and good surface wear resistance of such coatings.

Unfortunately, even the use of advanced glass release coatings fails to completely solve the problem of glass adherence to mold surfaces after a few hundreds of glass-forming cycles. Eventually, the molds become sticky with respect to the glasses being formed, leading again to glass adherence to mold surfaces that cause surface defects in the formed glass articles. Thus, in all cases, the replacement or resurfacing of these coated molds, at considerable expense, becomes unavoidable.

Mold replacement can offer the only solution to the sticking problem for uncoated molds, whereas in the case of coated molds, mold resurfacing methods can be used. Up to the present time the most effective methods for resurfacing coated molds have involved removing the worn coatings, for example by machining or chemical dissolution, followed by the application of new coating layers. However, the removal and recoating steps required to replace the exhausted coatings are time-consuming and expensive. Thus more effective and economic methods for extending the services lives of glass forming molds used for the shaping of hard, chemically aggressive glasses are needed.

### SUMMARY

In accordance with the present disclosure, a method for reconditioning rather than replacing a titanium aluminum nitride glass release coating disposed on the surface of a glass forming mold is provided. The method derives in part from our discovery of the underlying cause of glass adherence to such coatings following repeated contact with hot alkali-containing glasses. Without intending to be bound by theory, evidence suggests that the top surface of these coatings becomes oxidized during use to form a thin but dense aluminum oxide layer. That layer likely helps to retard oxygen diffusion into the coatings during use, but at the same time is found to be strongly reactive toward Na₂O and SiO2, interacting with hot glasses during molding to form an sodium enriched aluminum silicate surface layer on the Ti—Al—N coating, this glass components enriched coating top oxide has relatively low liquidus phase and can result in glass sticking to mold coating during forming the increased coating stickiness eventually leads to degraded surface cosmetics in the molded glass articles and failure of coating.

Among the various embodiments of the invention provided in accordance with the present disclosure are methods for reconditioning surface-coated glass-forming molds incorporating surface-oxidized titanium aluminum nitride release coatings. In accordance with those methods a surface-oxidized titanium-aluminum-nitride-containing glass release coating disposed on the surface of a glass-forming mold is contacted with an aqueous mineral acid solution comprising a combination of fluoride and phosphate ions. In particular embodiments, the surface-oxidized release coating to be contacted comprises a glass-adhering surface oxidation layer comprising oxygen, aluminum, and alkali metal. In those and other embodiments the surface oxidation layer is a nitrogen-depleted layer, and/or a surface oxidation layer comprising silicon and sodium and aluminum.

In further embodiments, the present invention comprises a glass-forming mold supporting a reconditioned titanium-aluminum-nitride-based release coating processed in accordance with the methods disclosed herein. As distinguished from both a newly-deposited titanium-aluminum-nitride-based release coating and an exhausted coating exhibiting high surface concentrations of alkali, silicon and oxygen, a reconditioned coating provided in accordance with embodiments of the present invention is substantially free of surface nitrogen depletion but comprises measurable surface concentrations of diffused alkali metal, silicon, and oxygen.

In still further embodiments the present invention comprises methods for forming a glass article from an ion-exchange-strengthenable high-alkali aluminosilicate glass. Those methods comprise the step of contacting and shaping the glass with a glass-forming mold having a metal mold base supporting a titanium-nitride-based glass release coating, wherein the titanium-nitride-based release coating is a reconditioned coating that is substantially free of surface nitrogen depletion but that comprises measurable surface concentrations of diffused alkali metal, silicon, and oxygen.

### BRIEF DESCRIPTION OF THE DRAWINGS

Particular embodiments of the disclosed invention are further described below with reference to the appended drawings, wherein:

FIG. 1 is an electron photomicrograph of a Ti—Al—N-coated glass-forming mold;

FIG. 2 is a plot of oxygen surface concentration in a Ti—Al—N glass release coating;

FIG. 3 is a plot of diffused alkali metal surface concentration in a Ti—Al—N glass release coating;

FIG. 4 is a plot of diffused silicon surface concentration in a Ti—Al—N glass release coating;

FIG. 5 is a plot illustrating nitrogen depletion in a Ti—Al—N glass release coating;

FIG. 6 plots material removal from a metal alloy glass-forming mold.

### DETAILED DESCRIPTION

While the methods of the present invention can be usefully applied to recondition glass release coatings employed for molding a wide variety of moldable glass compositions, they are of particular advantage for the refreshment of coatings used for the forming of high-melting (“hard”) alkali aluminosilicate glasses. Thus the present methods effectively remove the out diffused alkali (e.g., sodium), alkali earth and silicon from Ti—Al—N-based release coatings that are the major cause of glass sticking in the forming of such glasses. In accordance with the present disclosure Ti—Al—N-based coatings are restored to their nearly original compositions, greatly extending coating service life and thus reducing the need for coating replacement.

Previous treatments for the dissolution of glassy residues accumulated on mold and mold-release-coated surfaces have not proven successful for reconditioning Ti—Al—N release coatings having surfaces accumulated with the combination of alkali, silicon and oxygen introduced in the course of molding alkali aluminosilicate glasses. In some cases such treatments were ineffective to reduce the concentrations of glass components to usefully low levels, while in other cases the treatments were damaging to the underlying metal mold materials. Selected embodiments of the present invention are particularly well adapted for the restoration of glass-forming tooling comprising a metal mold base supporting a high temperature release coating composed at least predominantly of titanium-aluminum nitride (i.e., consisting of greater than 80 atomic percent total of titanium, aluminum and nitrogen), wherein the release coating comprises a glass-adhering surface oxidation layer comprising mainly oxygen, aluminum, silicon and alkali metal and other alkali earth elements.

In particular embodiments, the methods of the present invention are used to restore release coatings on tooling wherein the molds comprise a metal mold base fabricated of nickel-based metal alloys. Specific embodiments of such molds include nickel-chromium-iron-based metal alloys such as the Inconel™ alloys. Many of those alloys consist principally (at least 80% total by weight) of nickel, chromium and iron with minor additions of such other constituents as Mo, Nb, Co, Mn, Cu, and the like, a particular embodiment of such a metal mold base being one fabricated of Inconel™ 718 alloy.

The specific combination of coating constituents present in Ti—Al—N release coatings to be treated in accordance with the present disclosure may vary widely, a number of such formulations having been employed in the prior art for improving the glass release characteristics of metal glass-forming molds. Coatings composed of titanium aluminum nitride alone or alloyed with minor proportions of constituents selected from the group consisting of Si, Nb, Y, and Zr have been shown to be effective to minimize interfacial reactions between metal glass-forming molds and molten glasses during high temperature forming processes, and can be successfully treated. Particular examples of such release coatings that provide good oxidation resistance together with good anti-sticking properties include coatings consisting essentially of an alloy selected from the group consisting of TiAlN, TiAlSiN, TiAlNbN, TiAlSiNbN, TiAlZrN, TiAlYN and mixtures thereof.

The mode of coating degradation accompanying the use of such release coatings to form molded alkali aluminosilicate glass articles is presently understood to be as follows. At high forming temperature, TiAlN coating top formed a self-limiting layer of oxide compose of Al2O3 on the top with TiO2 underneath it. During thermal forming with high alkali glass, glass components such as Na, Si, Ca, Mg, etc. diffuse into coating top oxide, especially Si and Na. that have significant accumulation into coating oxide, leading to the formation of sodium enriched alumina silicate that has relatively lower liquidus phase. That becomes increasingly “sticky” with respect to the molten aluminosilicate glass being formed.

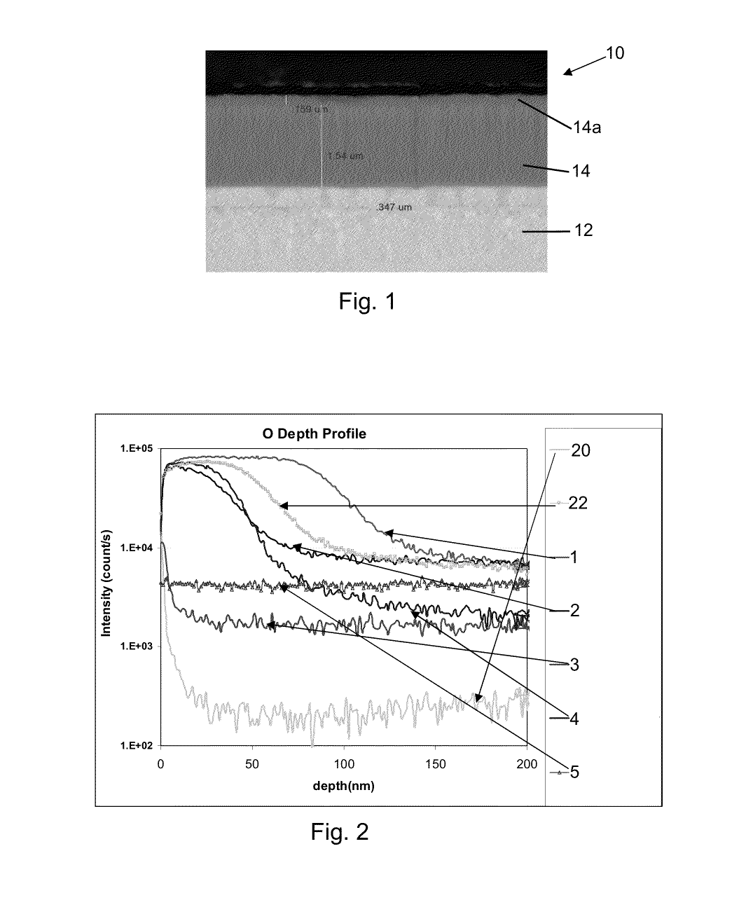

A release-coated metal glass-forming mold of the kind treated in accordance with embodiments of the present invention is illustrated in FIG. 1 of the drawings. FIG. 1 comprises an electron photomicrograph of a cross-section of a metal glass-forming mold 10 consisting of an Inconel™ 718 nickel alloy mold base 12 provided with a Ti—Al—N release coating 14 of approximately 1.7 μm thickness on the mold surface. The coated mold shown in FIG. 1 is a mold that has been subjected to 200 thermal glass-forming cycles in the course of molding glass articles from an alkali aluminosilicate glass. As a consequence of this use, release coating 14 has developed a surface oxidation layer 14a of approximately 0.159 μm thickness on the surface of release coating 14, that layer exhibiting significant adherence to molten alkali aluminosilicate glasses. Among the aluminosilicate glasses that can cause the kinds of coating degradation shown in FIG. 1 are ion-exchange-strengthenable, high-alkali aluminosilicate glasses, including for example sodium aluminosilicate glasses comprising at least 10% by weight of sodium. Particularly useful embodiments of the methods of the present invention are those treatments that can effectively recondition degraded titanium-aluminum mold coatings employed for the molding of such glasses.

Surface oxidation, surface nitrogen depletion, and alkali and silicon builds up on the surface of a Ti—Al—N-based mold coating can become significant after a relatively small number of molding cycles in cases where the glass being molded is a hard alkali aluminosilicate glass containing a substantial concentration of sodium. FIGS. 2-5 of the drawings comprise graphs reflecting surface concentration profiles for selected chemical species present at shallow coating depths proximate to the exposed (oxidized) surface of a Ti—Al—N-based glass release coating before and after 60 molding cycles in contact with such a glass. The species tracked in FIGS. 2-5, respectively, are oxygen, silicon, sodium and nitrogen. The relative concentrations of each of these species is reflected by curves plotting the relative intensities of the signals as a function of coating depth. The intensities are reported in counts per second as generated by standard SIMS (secondary ion mass spectrometry) analyses.

Referring in more detail to FIGS. 2-5, the set of SIMS curves presented in each of the Figures for each of the analyzed species includes a curve 20 reflecting species concentrations prior to exposure of the coating to molten glass, a curve 22 reflecting concentration in the surface-oxidized coating following exposure to 60 glass molding cycles, and curves 1, 2, 3, 4 and 5 reflecting, respectively, the species concentrations following treatment of the surface-oxidized coating by one of 5 different treatment methods. Those methods, with numbers corresponding to the drawing curves, are as follows:

Method 1: Exposure to a KOH based detergent (pH 13) in an ultrasonic bath at 60° C. for 15 minutes;

Method 2: Soaking in 120° C. 45% KOH for 15 min, and then room temperature 5% HC1 for 40 minutes;

Method 3: Soaking in a mixture of 10 ml HCl, 150 ml H₃PO₄ and 10 ml HF at 70° C. for 15 minutes;

Method 4: Soaking in a mixture of 10 ml HCl, 10 ml HF and 180 ml DI water at room temperature for 30 minutes; and

Method 5 Dry etching in CH₂F₂ for 15 minutes.

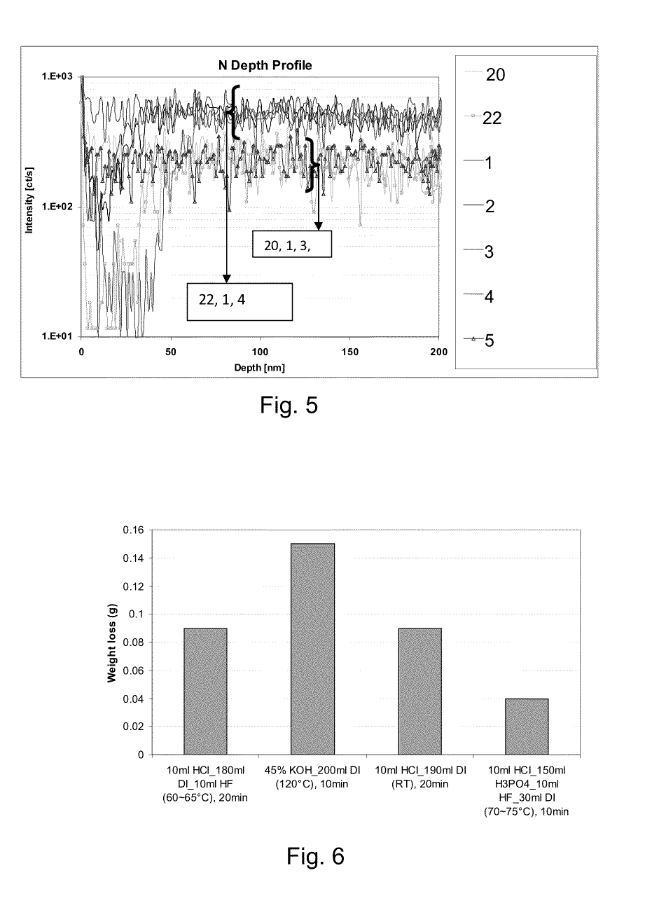

It is apparent from a comparison of oxygen concentration curves 20 and 22 in FIG. 2 of the drawings that significant oxygen diffusion into the release coating surface occurs within even a relatively short 60-cycle exposure to the molten glass. This oxygen enrichment is accompanied by a depletion of nitrogen from a surface region of the coating as evidenced by a comparison of curves 20 and 22 in FIG. 5 of the drawings. The nitrogen depletion occurring over this limited molding interval already extends to a coating depth of approximately 40 nm.

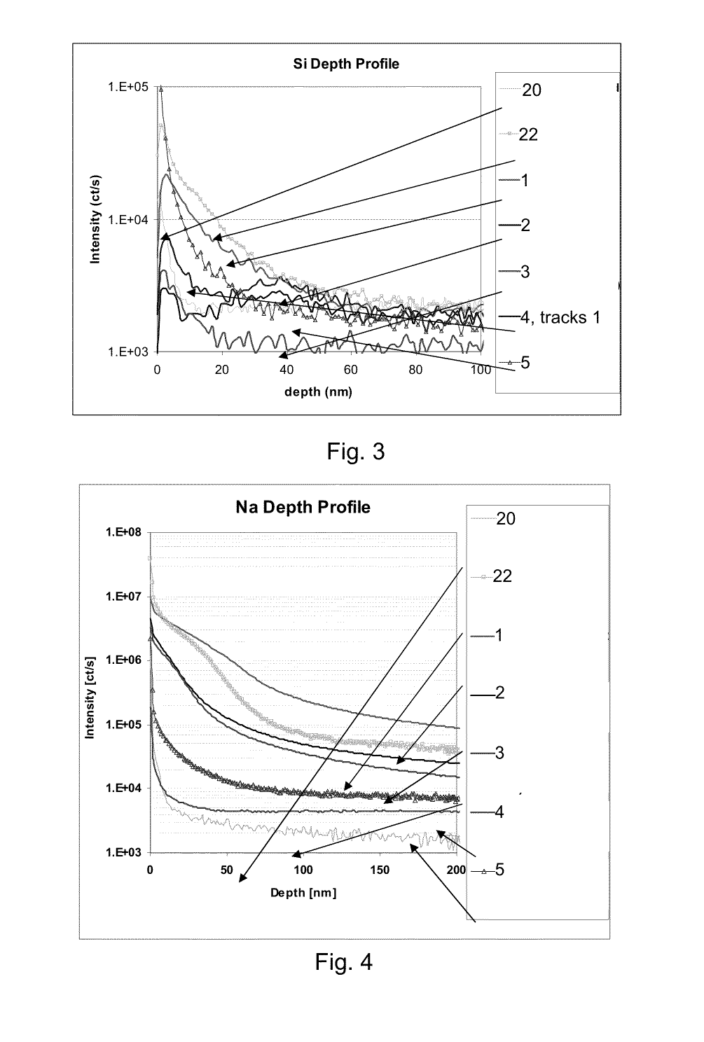

FIGS. 3 and 4 of the drawings reflect the extent of silicon and alkali migration into the oxidized Ti—Al—N-based coating. Curve 22 in FIG. 4 indicates a sodium concentration in the cycled coating that is approximately two orders of magnitude higher within a coating depth of 70 nm than is seen in the as-applied coating of curve 20, that sodium being largely concentrated in the oxidized layer indicated in FIG. 2. A similar increase in silicon concentration in the oxidized coating surface is indicated by curves 20 and 22 in FIG. 3 of the drawings.

The curves 1-5 included in each of FIGS. 2-5 of the drawings are indicative of the effectiveness of the corresponding treating methods listed above that were aimed at the reconditioning of nitrogen-depleted Ti—Al—N-based release coatings contaminated with oxygen, silicon and alkali to the levels indicated by curves 22 in those Figures. The use of KOH detergent solutions as employed in the practice of Methods 1 and 2 above are least effective for the removal of the oxidized/contaminated surface layers from such coatings, while the use of a dry CH₂F₂ etchant as prescribed by Method 5 results in non-uniform oxidation layer removal. The edge portions of a contaminated mold coating can be effectively reconditioned by dry etching in accordance with Method 5, whereas no visible reduction in surface oxidation is observed over centrally-located regions of the same coating.

Method 4 is relatively ineffective for reducing surface oxygen levels and reversing surface nitrogen depletion. In contrast, Method 3 involving the use of an acid solution comprising both fluoride and phosphate ions produces a reconditioned coating surface most closely approximating an as-applied release coating in terms of oxygen, silicon and alkali levels, while at the same time effectively addressing nitrogen depletion in the reconditioned coating surface. Particular embodiments of the disclosed methods involving treatment of surface-oxidized release coating surfaces with acid solutions comprising a combination of H₃PO₄, HCl and HF have been found to be unexpectedly effective in both removing surface contamination and restoring the glass-release properties of Ti—Al—N-based release coatings such as herein described.

Release coatings treated with acidic solutions comprising these three acids are clearly distinguishable from both newly-deposited titanium-aluminum-nitride-based release coatings and exhausted (surface-oxidized) coatings exhibiting high surface concentrations of alkali, silicon and oxygen contaminants. Thus reconditioned coatings provided in accordance with these embodiments comprise detectable subsurface concentrations of diffused alkali metal, silicon, and oxygen that are not present in freshly applied nitride release coatings, although the coatings nevertheless exhibit excellent glass release characteristics notwithstanding the presence of these concentrations. At the same time, and unlike exhausted or surface-oxidized nitride release coatings such as characterized by Curves 22 in FIGS. 1-5 of the drawings, reconditioned release coatings provided in accordance with the above-disclosed embodiments are substantially free of surface and subsurface nitrogen depletion as shown by Curve 3 in FIG. 5 of the drawings. For purposes of the present description a reconditioned nitride release coating is substantially free of nitrogen depletion if, as typified by Curve 3 in FIG. 5, SIMS analysis of the coating evidences no systematic difference in nitrogen concentration as between the coating surface and coating subsurface regions within 200 nm of that surface, within the measurement accuracy of the analysis.

A further advantage of acidic reconditioning solutions comprising a combination of fluoride and phosphate ions, in further combination with optional chloride ions, is a reduced tendency to attack metal mold base materials. Minimizing mold base material loss is important in order to avoid changes in mold shape during reconditioning. Significant material loss can result in mold configuration changes that are not acceptable where shape precision in a molded glass product is required. FIG. 6 of the drawings compares chloride-fluoride-phosphate reconditioning solutions with both KOH detergent solutions and acidic HCl and HCl—HF etching solutions in terms of the damage to an Inconel™ 718 metal alloy mold base material inflicted by dissolution in these solutions. Fluoride-chloride-phosphate solutions were found to be markedly superior to the other candidate reconditioning solutions for avoiding mold base material loss during release coating reconditioning.

For some applications it is important to maximize the rate of material removal from surface-oxidized nitride glass release coatings, not only to minimize mold base material loss but also to reduce processing costs. Table 1 below compares the efficiencies of various acidic fluoride-chloride-phosphate treating solutions for removing surface oxide material from oxidized nitride release coatings. The comparison is terms of the step height between treated and untreated sections of the coatings exposed to the solutions.

TABLE 1
Etching Step Height During Mold Coating Reconditioning

| | Etching step height |
|---|---|
| | (μm) |
| 10 ml HCl/10 ml HF/150 ml H3P04/ | 0.08 |
| 30 ml Dl | |
| 10 ml HCl/10 ml HF/100 ml H3P04/ | 0.01 |
| 80 ml Dl | |
| 10 ml HCl/5 ml HF/150 ml H3P04/ | 0.05 |
| 30 ml Dl | |
| 10 ml HCl/0 ml HF/150 ml H3P04/ | 0.02 |
| 30 ml Dl | |
| 10 ml HCl/0 ml HF/100 ml H3P04/ | 0.01 |
| 90 ml Dl | |

Analyses of data such as reported in Table 1 above indicate that phosphate ion concentration, and to a lesser extent fluoride ion concentration, are important variables affecting the rate of surface removal from alkali- and silicon-containing oxidized release coating surfaces. Based on such analyses, reconditioning methods employing treating solutions consisting essentially of H₃PO₄, HF, HCl and water at concentrations of about 2-15 M H₃PO₄, 0.5-5 M HF, and 0.2-0.8 M HCl offer particular advantages where rapid reconditioning is required. Exposure to such solutions at treatment temperature in the range of about 50-100° C., or in some embodiments 70-80° C., can be particularly effective.

While the invention has been described above with reference to particular embodiments of methods, coatings and molding methods provided in accordance therewith, it will be recognized that such embodiments have been presented for purposes of illustration only, and that various modifications of those and other embodiments may be adopted with advantage for the practice of the invention within the scope of the appended claims.

what is claimed is:

1. A method for reconditioning a surface-coated glass-forming mold comprising a step of contacting a surface-oxidized titanium-aluminum-nitride-containing glass release coating disposed on the mold with an aqueous mineral acid solution comprising fluoride and phosphate ions.

2. A method in accordance with claim 1 wherein glass-forming mold comprises a metal mold base and wherein the titanium-aluminum-nitride-containing glass release coating is a high-temperature release coating composed at least predominantly of TiAlN.

3. A method in accordance with claim 2 wherein the glass release coating is composed of TiAlN alone or alloyed with one or more of Si, Nb, Y and Zr.

4. A method in accordance with claim 2 wherein the glass release coating consists essentially of an alloy selected from the group consisting of TiAlN , TiAlSiN, TiAlSiNbN and TiAlNbN, TiAlZrN, TiAlYN and mixtures thereof.

5. A method in accordance with claim 1 wherein the glass release coating comprises a glass-adhering surface oxidation layer comprising oxygen, aluminum, silicon and alkali metal.

6. A method in accordance with claim 5 wherein the glass-adhering surface oxidation layer is a nitrogen-depleted layer.

7. A method in accordance with claim 1 wherein the aqueous mineral acid solution comprises an acid mixture of HF, HCl and H₃PO₄.

8. A method in accordance with claim 7 wherein the acid mixture has acid concentrations falling within the ranges of 2-15 M H₃PO₄, 0.2-5 M HF and 0.2-0.8 M HCl.

9. A method in accordance with claim 2 wherein the metal mold base is composed of a nickel-based metal alloy.

10. A glass-forming mold comprising a metal mold base supporting a reconditioned titanium-aluminum-nitride-based release coating provided in accordance with the method of claim 1.

11. A glass-forming mold in accordance with claim 10 wherein the reconditioned titanium-aluminum-nitride-based release coating has a surface layer comprising alkali metal, silicon aluminum and oxygen that is substantially free of nitrogen depletion.

12. A glass-forming mold in accordance with claim 10 wherein the metal mold base is formed of a nickel-based metal alloy.

13. A method for forming a glass article from a charge of an ion-exchange-strengthenable high-alkali aluminosilicate glass comprising the step of contacting the charge with a glass-forming mold having a metal mold base supporting a titanium-aluminum-nitride-based glass release coating, wherein the titanium-nitride-based release coating is a reconditioned coating provided in accordance with the method of claim 1.

14. A method in accordance with claim 13 wherein the reconditioned titanium-aluminum-nitride-based release coating has a surface layer comprising alkali metal, silicon, aluminum and oxygen that is substantially free of nitrogen depletion.

15. A method in accordance with claim 13 wherein the ion-exchange-strengthenable high-alkali aluminosilicate glass is a sodium aluminosilicate glass comprising at least 10% by weight of sodium.
